(19) United States
(12) Patent Application Publication
(10) Pub. No.: US 2002/0091803 A1
(43) Pub. Date: Jul. 11, 2002

(54) Multi-user management process enabling user privacy for use in a network entertainment center

(76) Inventors: Kokoro Imamura, La Jolla, CA (US); Srikant Char, Poway, CA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 09/908,234

(22) Filed: Jul. 18, 2001

Related U.S. Application Data
(60) Provisional application No. 60/260,116, filed on Jan. 8, 2001.

(51) Int. Cl. G06F 15/177

(52) U.S. Cl. 709/220; 709/228

(57) ABSTRACT

A method and apparatus enables accessing of the Internet by multiple users of a common device. Each user's cached information is uploaded to a predetermined server as part of a log-off process. Each user's cached information is also downloaded from the predetermined server as part of a log-on process. A processor in the common device executes a multi-user management process manages the users' cached information. The multi-user management process stores the user's cached information in local memory upon downloading it from the predetermined server, thereby enabling a browser application to function as if customized by each user. The browser application retrieves the cached information stored in local memory and updates the cached information during its logon session with a particular user, thereby ensuring the cached information remains up to date.

### RELATED APPLICATIONS

This application claims priority to U.S. Provisional Application No. 60/260,116 filed on Jan. 5, 2001 by the same inventors.

### COPYRIGHT NOTICE

A port of the disclosure of this patent document contains material that is subject to copyright protection. The copyright owner has no objection to the facsimile reproduction of the patent document or the patent disclosure, as it appears in the U.S. Patent & Trademark Office patent file or records, but otherwise reserves all copyright rights whatsoever.

### BACKGROUND OF THE INVENTION

The present invention relates generally to methods and apparatuses for accessing the Internet and other computer networks, and more particularly to a method and apparatus for accessing the Internet or other computer network using a browser.

When one accesses the Internet using a common browser application executing on one's computer or Internet appliance, the user's preferences, favorite list, history data and cookies are updated and stored on the user's machine. When the user next logs on, these settings enable the user to more quickly access commonly accessed servers and websites. However, some of this information is indicative of users' habits, and may include confidential information. When multiple users share a common computer or Internet appliance, these users often must share this information or data. Many users find this undesirable.

The present invention is therefore directed to the problem of developing a method and apparatus for accessing the Internet or other computer network using a browser that executes on the user's computer or Internet appliance, which method and apparatus enables multiple users to share a common computer or Internet appliance without necessarily sharing browser settings and other user-specific data and preferences.

### SUMMARY OF THE INVENTION

The present invention solves this and other problems by providing a method and apparatus for accessing the Internet by multiple users of a common device in which each user's cached information is uploaded to a predetermined server as part of a log-off process, and each user's cached information is downloaded from the predetermined server as part of a log-on process.

According to one aspect of the present invention a processor in the common device executes a multi-user management process manages the users' cached information. The multi-user management process stores the user's cached information in local memory upon downloading it from the predetermined server, thereby enabling a browser application to function as if customized by each user. The browser application retrieves the cached information stored in local memory and updates the cached information during its logon session with a particular user, thereby ensuring the cached information remains up to date.

### BRIEF DESCRIPTION OF THE DRAWINGS

FIG. 1 depicts an exemplary embodiment of a system according to one aspect of the present invention.

FIG. 2 depicts an exemplary embodiment of a method according to one aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

System Overview

The present invention finds application in Sony's eVilla Network Entertainment Center, which provides Internet access for entertainment and communication without the complications of a computer. It is conveniently packaged with hardware, software and a dedicated Internet Service Provider (ISP). The eVilla is designed with the Internet in mind with email, a web-friendly display, browser, and preloaded multimedia software.

The eVilla includes a display depicting the way the Internet was meant to be viewed. A large 15″ (14″ viewable) FD Trinitron® Portrait View display combines high-resolution with up to ⅓ more viewing space, reducing unnecessary scrolling.

The eVilla is easily powered on. With the touch of a button, hassles waiting to boot-up are reduced since email and web content are updated daily.

Software management is simplified. All software necessary to operate eVilla is pre-loaded and will be managed for the user—no hassles, just fun.

A powerful and elegant Graphical User Interface (GUI) is provided. The GUI is simple, uncluttered, and intuitive—easy enough for the Internet beginner, yet strong enough for the power user.

Automatic Email and Web Content Updates are provided. Daily automatic updates enable one to read and compose email and access customized web content in an offline mode with the touch of a button while one's telephone line remains open to callers. Of course, one can always go on-line whenever one prefers.

Multimedia-Internet Entertainment is made easy. Plug-in support and organized channels simplifies listening to Internet music and radio, and viewing images and video. Built-in stereo speakers and audio output jack helps you get the most from Internet radio and streaming audio.

Fun Communication is possible. One can view and send email with pictures, video, and audio attachments.

Multiple users can enjoy this device. Each eVilla on-line account allows for up to four unique users including private email addresses, separate bookmarks, cookies and preferences.

The eVilla comes with a Memory Stick® Media Slot. With 10 million Memory Stick media users and counting, enjoy the most convenient way to store and share digital information.

Multiple USB ports are provided. The device supports multiple printers and external storage devices through at least two USB ports.

A V.90 Modem and Ethernet Port are provided. Connection to the Internet is possible using a regular telephone line. An Ethernet port may also be included for broadband connectivity.

The device operates silently. No fan eliminates noise.

Log-In Manager

In a device with a plurality of users registered therein, enabling a particular user to log-in to the device, the multi-user management process according to one embodiment would download from the server or local side cached information associated with the particular user. Hence, the multi-user management process serves as a convenient way where a particular user can log in and have all his settings associated with a web browser therein. For example, upon logging in, a user's address book, bookmarks and other parameters would be retrieved and stored locally. Such storage could be in flash memory.

Upon logging out, the user's parameter or changes to the parameter associated therewith would be sent to the server side or to the ISP provider and would be stored therein. The locally stored information, the information in the flash memory would be cleared. Another user logging in would not have access to the above user's particular parameters. The second user upon logging in would be locally updates with his parameters associated therewith. The second user would not have access nor would have notice of the parameters associated with the above user. Therefore, the privacy or confidentiality of both users would be maintained.

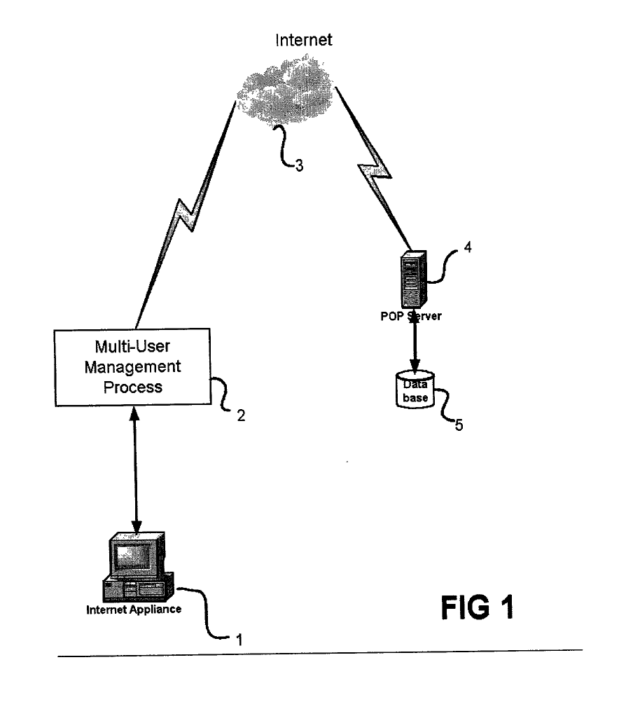

Referring to FIG. 1, shown therein is a shared apparatus 1 for accessing the Internet 3 or other computer network by multiple users. Each apparatus 1 includes at least a processor and a memory. The processor used in the present invention may be a general purpose computer. Also, those or ordinary skill in the art will recognize that the processor may be any device that can communicate with, and receive information from, a distributed computer network, such as the Internet 3. For example, the processor may be a web-enabled television, telephone or other online appliance providing network connectivity.

The processor executes a multi-user management process 2 that uploads each user's cached information to a predetermined server 4 on the Internet 3 whenever each user logs off the shared apparatus or Internet. The term “server” can include the hardware, the software, or both because the software programs may dynamically be assigned to different server computers depending on load conditions. Servers typically maintain large centralized data repositories for many users. When this user re-logs on to the shared apparatus or Internet, this user's cached information is downloaded from the predetermined server 4 (or a database 5) into the local memory of the shared apparatus 1.

When the user initiates a browser application to access the Internet or other computer network, the user's cached information is retrieved from the local memory to customize the appearance and operation to that user. As the user browses the Internet with the browser installed on the shared apparatus cached information is continuously updated and stored in the local memory. Thus, when the user logs off, the data stored in the local memory includes all current cookies, bookmarks, addresses, etc. When this user then returns and logs back on, the manager process downloads this data and replaces the contents of the memory with this data. When the browser is then initiated, the browser includes all user specific content and format. Each user therefore feels as though the browser was customized for him or her, and that the computer is his or her own. Moreover, each user's privacy is protected because no other user has access to this cache information, which is securely stored on the predetermined server.

The shared apparatus includes a processor that executes a multi-user management process. This management process controls the user cache information uploading and downloading to the predetermined server. When the user indicates that he or she wishes to log off of the Internet or other computer network, the management process copies the cache information file and uploads it to the predetermined website. Once this information is successfully stored on the website, including error correction and detection processes being completed, the management process releases the logoff process to complete its logoff. Subsequently, the management process clears the memory of the cache information so subsequent users cannot access this information, thereby ensuring the privacy of each user from each other user. When a new user logs on, the management process accesses the predetermined server, downloads the new user's previously stored cache information, and stores this cache information on the local memory for access by the browser application. This customizes the browser to the new user, as previously specified by the new user.

When a user first logs onto the shared device, the user's cache is stored on the predetermined server for the first time. A file is created for the user and opened on the server. Whenever this user logs off in the future, the file is overwritten with the latest version of the cache information.

The browser application accesses the Internet and includes user-specific preferences and history, which are stored in the cached information. Any standard browser application may suffice, such as Internet Explorer or Netscape Navigator. Each of these browser applications stores user specific information in files on the user's hard disk or memory device. In the present invention, these files are copied and stored on a server accessible by the user externally to the browser application, thereby enabling the browser application to work independently and seamlessly with the management process. In the normal manner, the browser application updates the user's cached information in the local memory.

The predetermined server stores whatever cached information a user may require. Some examples include a user's address book, one or more bookmarks, history, preferences, user identification information, data to support features such as autocompletion of email addresses or other entries, etc. This information can also include one or more cookies, digital certificates, encryption keys, etc.

The memory in the shared device stores a user's cached information after the multi-user management process downloads the user's cached information. As part of the logoff process, the multi-user management process clears a user's cached information from the memory, if it is successful in uploading the user's cached information to the server.

Any convention memory may suffice. Some possible examples include memory sticks, flash memory, random access memory (RAM), Read Only Memory (ROM), electrically erasable programmable ROM or RAM. One possible example includes a memory stick that is removable by each user, thereby providing additional privacy for each user.

Another possible example of a memory is a ring buffer. By controlling the location of the pointer of the ring buffer, one can enable overwriting of other users' cache information while simultaneously limiting the amount of data stored in one's cache.

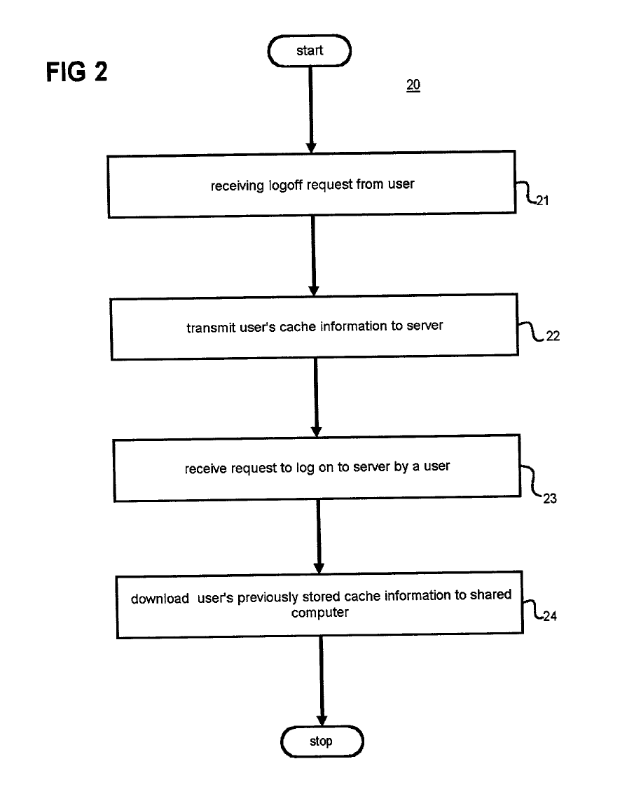

Shown in FIG. 2 is a method 20 for accessing a computer network by multiple users of a common device. Upon receipt of a user command 21 to logout of the computer network or off the common or shared device, the user's cached information is sent to a predetermined server on the computer network 22. This server can be a server associated with the manufacturer of the common or shared device or a host server specified by the user. The server can also be a server associated with the Internet Service Provider (ISP). Upon receipt of a command from a user to logon 23 the computer network or Internet or common device, the cached information for the particular user is downloaded into the local memory 24 for subsequent use by a browser application.

According to one aspect of the present invention, the user cached information for a particular user is only stored in the local memory of the common device when the particular user is logged on. At all other times, this information is securely stored on a server that is accessible only by the particular user. Whenever the user logs off the computer network or the shared device, the memory contents are purged, thereby protecting each user's privacy relative to each other.

The above embodiments can be encoded on a computer readable medium, such as a diskette, flash memory, ROM, RAM, EEPROM, EPROM, magnetic tape, optical disk, CD, etc. These encodings can cause a processor to perform the above-described methods.

Although various embodiments are specifically illustrated and described herein, it will be appreciated that modifications and variations of the invention are covered by the above teachings and within the purview of the appended claims without departing from the spirit and intended scope of the invention. For example, while several of the embodiments depict the use of specific data formats and protocols, any formats or protocols may suffice. Moreover, while some of the embodiments describe specific embodiments of computer, clients, servers, etc., other types may be employed by the invention described herein. Furthermore, these examples should not be interpreted to limit the modifications and variations of the invention covered by the claims but are merely illustrative of possible variations.

What is claimed is:

1. An apparatus for accessing the Internet by multiple users comprising:
a processor to execute a multi-user management process that uploads cached information to a predetermined server on the Internet when each user logs out and downloads cached information for each user when each user logs on; and
a browser application to access the Internet and including a plurality of user-specific settings and history being stored in the cached information.

2. The apparatus according to claim 1, wherein the cached information includes a user's address book, and one or more bookmarks.

3. The apparatus according to claim 1, wherein the cached information includes one or more cookies.

4. The apparatus according to claim 1, wherein the cached information includes history information for a user.

5. The apparatus according to claim 1, further comprising a memory to store a user's cached information after downloading the user's cached information by the multi-user management process.

6. The apparatus according to claim 5, wherein said multi-user management process clears a user's cached information from said memory after successfully uploading the user's cached information.

7. The apparatus according to claim 5, wherein said memory comprises a memory stick.

8. The apparatus according to claim 5, wherein said memory comprises flash memory.

9. The apparatus according to claim 5, wherein said browser application updates the user's cached information in said memory.

10. The apparatus according to claim 5, wherein said memory comprises a ring buffer.

11. A method for accessing a computer network by multiple users of a common device comprising:
uploading user cached information for a particular user to a predetermined server on the computer network upon said particular user logging out; and
downloading user cached information for the particular user when said particular user logs in.

12. The method according to claim 11, further comprising storing the user cached information for a particular user in a memory of the common device when the particular user is logged on.

13. The method according to claim 12, further comprising clearing the user cached information from the memory in the common device after uploading the user cached information.

14. The method according to claim 11, further comprising storing the user cached information in a removable memory stick that is insertable into the common device.

15. The method according to claim 11, further comprising storing the user cached information in a flash memory of the common device.

16. The method according to claim 11, further comprising storing the user cached information in a ring buffer of the common device.

17. The method according to claim 11, further comprising updating the user cached information stored in the memory of the common device when a user is logged onto the computer network.

18. The method according to claim 11, wherein the local cached information includes user specific preferences and data associated with a browser application to be executed by the common device.

19. The method according to claim 18, wherein the local cached information stored in the memory of the common device is updated by the browser when the browser accesses the computer network.

20. The method according to claim 11, wherein the cached information includes a user's address book, and one or more bookmarks.

21. The method according to claim 11, wherein the cached information includes one or more cookies.

22. The method according to claim 11, wherein the cached information includes history information for a user.

23. A method for managing multiple users of a common device comprising:
providing a predetermined server for storing user cache data;
uploading a first user's cache data to the predetermined server when said first user logs off the common device; and
downloading a first user's cache data from the predetermined server when saud first user logs on the common device.

24. The method according to claim 23, further comprising maintaining a file for each user on the predetermined server of a plurality of common devices.

25. The method according to claim 23, further comprising uploading a second user's cache data to the predetermined server when said second user logs off the common device.

26. The method according to claim 25, further comprising downloading the second user's cache data from the predetermined server to a local memory in the common device when said second user logs on the common device.

27. The method according to claim 24, further comprising creating a file for a particular user on the predetermined server for storing the particular user's cache data when said particular user logs off the common device after an initial registration process.
